(19) United States
(12) Patent Application Publication
(10) Pub. No.: US 2004/0258319 A1
(43) Pub. Date: Dec. 23, 2004

(54) Spatial scalable compression scheme using adaptive content filtering

(76) Inventor: Wilhelmus Hendrikus Alfonsus Bruls, Eindhoven (NL)

Correspondence Address: Corporate Patent Counsel, Philips Electronics North America Corporation, P.O Box 3001, Briarcliff Manor, NY, 10510, US

(21) Appl. No.: 10/493,275

(22) PCT Filed: Oct. 16, 2002
(86) PCT No.: PCT/IB02/04297

(30) Foreign Application Priority Data
Oct. 26, 2001 (EP) 01204066.3
Mar. 8, 2002 (EP) 02075918.9

(51) Int. Cl. G06K 9/36

(52) U.S. Cl. 382/240

(57) ABSTRACT

A more efficient spatial scalable compression scheme using adaptive content filtering is disclosed. The amount of video compression of a spatial scalable compression scheme is increased by the introduction of a multiplier on the residual stream of the enhancement layer. The multiplier is controlled by gain values for each pixel or group of pixels in each frame of video from a picture analyzer, wherein the gain values tend toward zero for areas with little or no detail and tends toward one for edges and text. Thus, the multiplier acts as a filter to reduce the amount of bits spent on irrelevant data of the enhancement layer. The multiplier also allows dynamic resolution compression.

### FIELD OF THE INVENTION

The invention relates to a video encoder/decoder, and more particularly to a video encoder/decoder with spatial scalable compression schemes using adaptive content filtering or dynamic resolution.

### BACKGROUND OF THE INVENTION

Because of the massive amounts of data inherent in digital video, the transmission of full-motion, high-definition digital video signals is a significant problem in the development of high-definition television. More particularly, each digital image frame is a still image formed from an array of pixels according to the display resolution of a particular system. As a result, the amounts of raw digital information included in high-resolution video sequences are massive. In order to reduce the amount of data that must be sent, compression schemes are used to compress the data. Various video compression standards or processes have been established, including, MPEG-2, MPEG-4, and H.263.

Many applications are enabled where video is available at various resolutions and/or qualities in one stream. Methods to accomplish this are loosely referred to as scalability techniques. There are three axes on which one can deploy scalability. The first is scalability on the time axis, often referred to as temporal scalability. Secondly, there is scalability on the quality axis (quantization), often referred to as signal-to-noise (SNR) scalability or fine-grain scalability. The third axis is the resolution axis (number of pixels in image) often referred to as spatial scalability. In layered coding, the bitstream is divided into two or more bitstreams, or layers. Each layer can be combined to form a single high quality signal. For example, the base layer may provide a lower quality video signal, while the enhancement layer provides additional information that can enhance the base layer image.

In particular, spatial scalability can provide compatibility between different video standards or decoder capabilities. With spatial scalability, the base layer video may have a lower resolution than the input video sequence, in which case the enhancement layer carries information which can restore the resolution of the base layer to the input sequence level.

FIG. 1 illustrates a known spatial scalable video encoder 100. The depicted encoding system 100 accomplishes layer compression, whereby a portion of the channel is used for providing a low resolution base layer and the remaining portion is used for transmitting edge enhancement information, whereby the two signals may be recombined to bring the system up to high-resolution. The high resolution video input is split by splitter 102 whereby the data is sent to a low pass filter 104 and a subtraction circuit 106. The low pass filter 104 reduces the resolution of the video data, which is then fed to a base encoder 108. In general, low pass filters and encoders are well known in the art and are not described in detail herein for purposes of simplicity. The encoder 108 produces a lower resolution base stream which can be broadcast, received and via a decoder, displayed as is, although the base stream does not provide a resolution which would be considered as high-definition.

The output of the encoder 108 is also fed to a decoder 112 within the system 100. From there, the decoded signal is fed into an interpolate and upsample circuit 114. In general, the interpolate and upsample circuit 114 reconstructs the filtered out resolution from the decoded video stream and provides a video data stream having the same resolution as the high-resolution input. However, because of the filtering and the losses resulting from the encoding and decoding, loss of information is present in the reconstructed stream. The loss is determined in the subtraction circuit 106 by subtracting the reconstructed high-resolution stream from the original, unmodified high-resolution stream. The output of the subtraction circuit 106 is fed to an enhancement encoder 116 which outputs a reasonable quality enhancement stream.

Although these layered compression schemes can be made to work quite well, these schemes still have a problem in that the enhancement layer needs a high bitrate. Normally, the bitrate of the enhancement layer is equal to or higher than the bitrate of the base layer. However, the desire to store high definition video signals calls for lower bitrates than can normally be delivered by common compression standards. This can make it difficult to introduce high definition on existing standard definition systems, because the recording/playing time becomes too small.

### SUMMARY OF THE INVENTION

The invention overcomes the deficiencies of other known layered compression schemes by using adaptive content filtering to reduce the number of bits in the residual signal inputted into the enhancement encoder, thereby lowering the bitrate of the enhancement layer.

According to one embodiment of the invention, a method and apparatus for providing spatial scalable compression using adaptive content filtering of a video stream is disclosed. The video stream is downsampled to reduce the resolution of the video stream. The downsampled video stream is then encoded to produce a base stream. The base stream is upconverted to produce a reconstructed video stream. The video stream and the reconstructed video stream are then analyzed to produce a gain value of the content of each pixel or group of pixels in the frames of the received video streams. The reconstructed video stream is subtracted from the video stream to produce a residual stream. The residual stream is attenuated by a multiplier with a variable gain factor so as to remove bits from the residual stream which represent areas of each frame which have little detail. The resulting residual stream is then encoded and outputting an enhancement stream.

According to another embodiment of the invention, the gain value of the attenuator outputted from the picture analyzer can be combined with the normal bitrate control from the enhancement encoder so as to allow for coding a variable overall resolution depending on the available bitrate budget of the enhancement encoder.

According to another embedment of the invention, a method and apparatus relating to sharpness control in the decoder is disclosed. The base stream is decoded and then upconverted to increase the resolution of the decoded base stream. The enhancement stream is decoded and then multiplied by a sharpness control value, wherein the sharpness control value controls the trade-off between sharpness and the visibility of artifacts in the decoded enhancement stream. Finally, the upconverted decoded base stream is combined with the sharpness controlled enhancement stream to produce a video output. These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram representing a known layered video encoder;

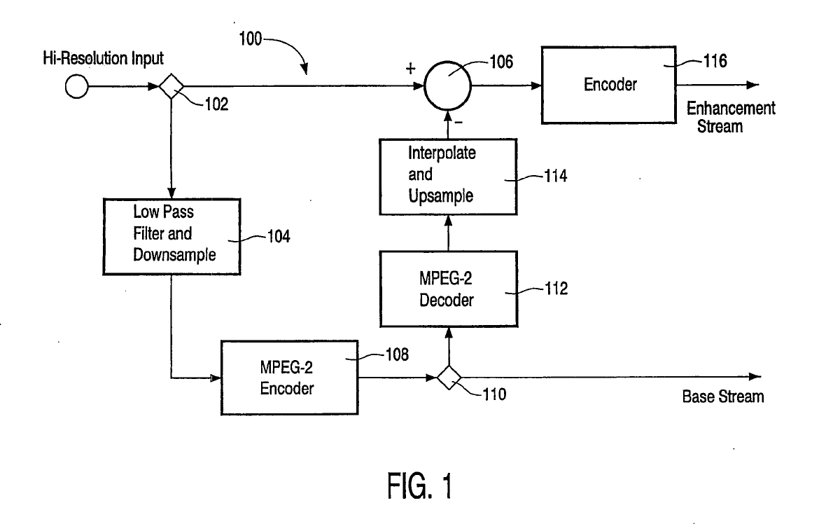

FIG. 2 is a block diagram of a layered video encoder/decoder according to an embodiment of the invention;

FIG. 3 is a block diagram of a layered video encoder/decoder according to an embodiment of the invention;

FIG. 4 is a block diagram of a layered video decoder according to an embodiment of the invention; and

FIG. 5 is a block diagram of a layered video encoder and layered video decoders according to a further embodiment of the invention.

### DETAILED DESCRIPTION OF THE INVENTION

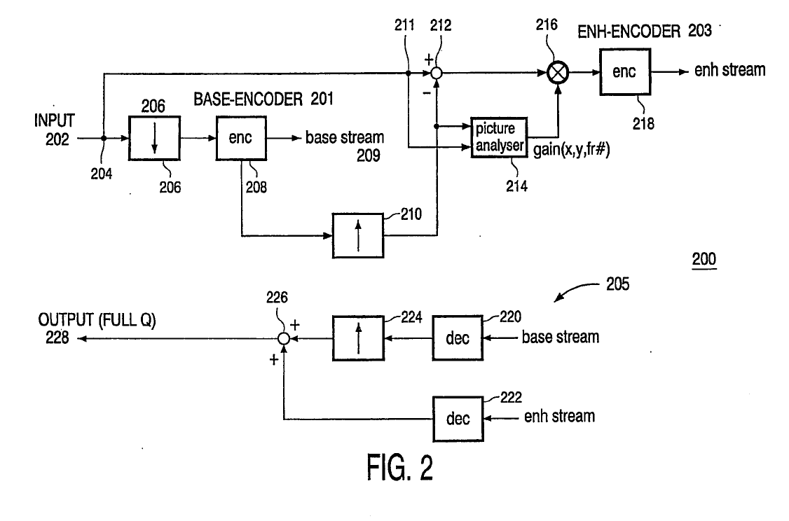

FIG. 2 is a block diagram of a layered video encoder/decoder 200 according to one embodiment of the invention. The encoder/decoder 200 comprises an encoding section 201+203 and a decoding section 205. A high-resolution video stream 202 is inputted into the base encoding section 201. The video stream 202 is then split by a splitter 204, whereby the video stream is sent to a low pass filter 206 and a second splitter 211. The low pass filter or downsampling unit 206 reduces the resolution of the video stream, which is then fed to a base encoder 208. The base encoder 208 encodes the downsampled video stream in a known manner and outputs a base stream 209. In this embodiment, the base encoder 208 outputs a local decoder output to an upconverting unit 210. The upconverting unit 210 reconstructs the filtered out resolution from the local decoded video stream and provides a reconstructed video stream having basically the same resolution format as the high-resolution input video stream in a known manner. Alternatively, the base encoder 208 may output an encoded output to the upconverting unit 210, wherein either a separate decoder (not illustrated) or a decoder provided in the upconverting unit 210 will have to first decode the encoded signal before it is upconverted.

The splitter 211 splits the high-resolution input video stream, whereby the input video stream 202 is sent to a subtraction unit 212 and a picture analyzer 214. In addition, the reconstructed video stream is also inputted into the picture analyzer 214 and the subtraction unit 212. The picture analyzer 214 analyzes the frames of the input stream and/or the frames of the reconstructed video stream and produces a numerical gain value of the content of each pixel or group of pixels in each frame of the video stream. The numerical gain value is comprised of the location of the pixel or group of pixels given by, for example, the x,y coordinates of the pixel or group of pixels in a frame, the frame number, and a gain value. When the pixel or group of pixels has a lot of detail, the gain value moves toward a maximum value of “1”. Likewise, when the pixel or group of pixels does not have much detail, the gain value moves toward a minimum value of “0”. Several examples of detail criteria for the picture analyzer are described below, but the invention is not limited to these examples. First, the picture analyzer can analyze the local spread around the pixel versus the average pixel spread over the whole frame. The picture analyzer could also analyze the edge level, e.g., abs of

| | | |
|---|---|---|
| −1 | −1 | −1 |
| −1 | 8 | −1 |
| −1 | −1 | −1 |

per pixel divided over average value over whole frame.

The gain values for varying degrees of detail can be predetermined and stored in a look-up table for recall once the level of detail for each pixel or group of pixels is determined.

As mentioned above, the reconstructed video stream and the high-resolution input video stream are inputted into the subtraction unit 212. The subtraction unit 212 subtracts the reconstructed video stream from the input video stream to produce a residual stream. The gain values from the picture analyzer 214 are sent to a multiplier 216 which is used to control the attenuation of the residual stream. In an alternative embodiment, the picture analyzer 214 can be removed from the system and predetermined gain values can be loaded into the multiplier 216. Alternatively, gain values can be entered by a user manually using, for example, a control knob (not illustrated). The effect of multiplying the residual stream by the gain values is that a kind of filtering takes place for areas of each frame that have little detail. In such areas, normally a lot of bits would have to be spent on mostly irrelevant little details or noise. But by multiplying the residual stream by gain values which move toward zero for areas of little or no detail, these bits can be removed from the residual stream before being encoded in the enhancement encoder 218. Likewise, the multiplier will move toward one for edges and/or text areas and only those areas will be encoded. The effect on normal pictures can be a large saving on bits. Although the quality of the video will be effected somewhat, in relation to the savings of the bitrate, this is a good compromise especially when compared to normal compression techniques at the same overall bitrate. The output from the multiplier 216 is inputted into the enhancement encoder 218 which produces an enhancement stream.

In the decoder section 205, the base stream is decoded in a known manner by a decoder 220 and the enhancement stream is decoded in a known manner by a decoder 222. The decoded base stream is then upconverted in an upconverting unit 224. The upconverted base stream and the decoded enhancement stream are then combined in an arithmetic unit 226 to produce an output video stream 228.

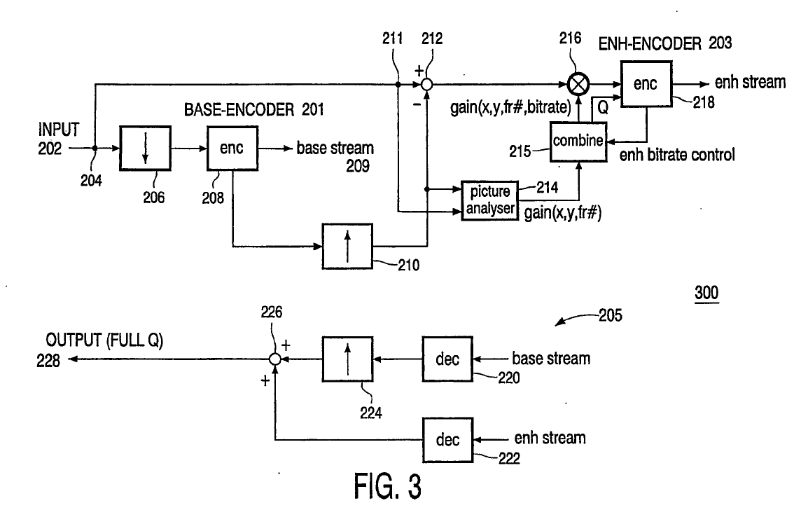

FIG. 3 illustrates an encoder/decoder 300 according to one embodiment of the invention. In this embodiment, the gain value sent to the multiplier is controlled by the available bitrate budget of the enhancement encoder. The bitrate control of the enhancement encoder can be extended by combining the gain values from the picture analyzer 214 with encoder statistics parameters from the enhancement encoder to produce final gain control parameters which are multiplied with the residual stream. The encoder/decoder 300 has all of the described elements of FIG. 2 which have been given like numbers in FIG. 3. For simplicity, the operations of the like elements will not be described herein.

In addition, the encoder/decoder 300 has a combination unit 215 located between the picture analyzer 214 and the multiplier 216. The combination unit 215 receives the gain value from the picture analyzer 214. In addition, the combination unit 215 receives enhancement parameters based on encoder statistics from the enhancement encoder 218. The combination unit 215 combines the encoder statistics parameters and the gain values and outputs final gain control parameters to the multiplier 216. The residual stream is then multiplied by the final gain control parameters before being encoded by the enhancement encoder 218. In other words, the gain values from the picture analyzer 214 are adjusted up or down depending on the available bitrate of the enhancement encoder. If the enhancement encoder has a small available bitrate budget, the gain values will be adjusted downward so that more bits will be filtered out of the residual stream. Likewise, if the enhancement encoder has a large available bitrate budget, the gain values will be adjusted upwards so that less bits will be filtered out of the residual stream. Thus, when the encoder statistics parameter indicates that the available bitrate budget is no longer sufficient for encoding at full resolution with sufficient quality, the gain of the multiplier 216 is set to a reduced resolution value in order to meet the available bitrate budget. This allows for coding a variable overall resolution depending on the available bitrate budget.

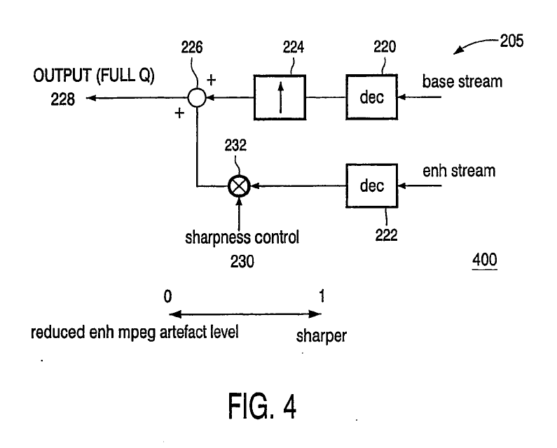

FIG. 4 illustrates a decoder 400 according to one embodiment of the invention. In FIG. 4, the decoder 400 has a sharpness control unit 230 and a multiplier 232 added to the decoder section 205. The sharpness control unit 230 allows the user to select a parameter between 0 and 1 wherein the lower the number leads to a greater reduction in the number of visible artifacts in the output video stream 228 and the higher the number leads to a sharper image of the output video stream 228. Thus, the sharpness control unit controls the trade-off between sharpness and the visibility of artifacts from the enhancement stream. The selected sharpness control parameter is inputted into the multiplier 232. The multiplier 232 then multiplies the decoded enhancement stream by the sharpness control parameter to adjust the sharpness and visibility of artifacts in the enhancement stream prior to combining the enhancement stream with the upconverted base stream in the arithmetic unit 226.

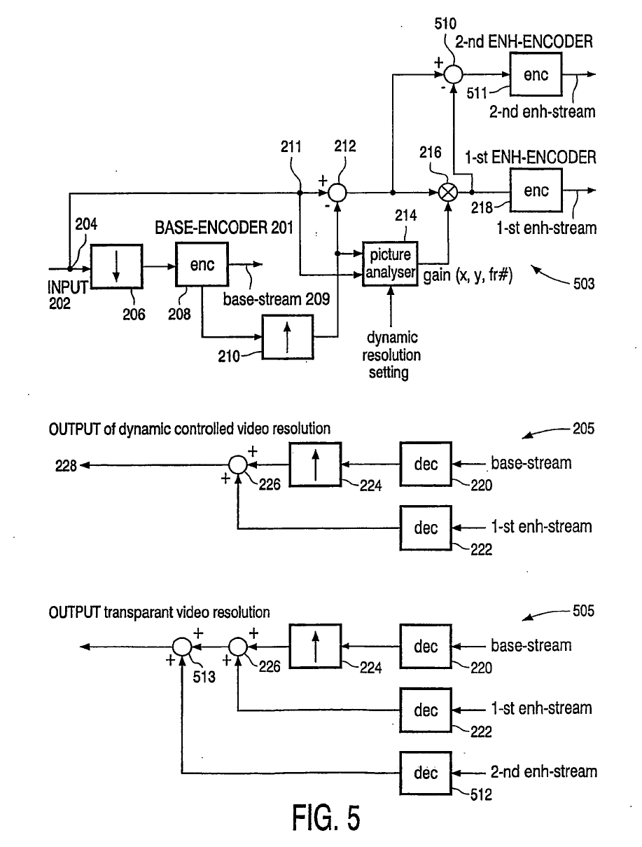

FIG. 5 shows a block diagram of a layered video encoder 503, the layered video decoder 205 and a layered video decoder 505. The video encoder 503 includes a subtractor 510 and a second enhancement encoder 511 added to the video encoder 203. The video encoder 503 can straightforwardly be enhanced with the combination unit 215 as shown in FIG. 3. FIGS. 2 and 3 show the use of a multiplier 216 to influence the input to the enhancement encoder 218 in order to provide adaptation of the enhancement layer. A disadvantage of the enhancement encoding shown in FIGS. 2 and 3 is that some picture details are lost and cannot be regenerated anymore because the multiplier operation of multiplier 216 is irreversible. The encoder 503 overcomes this problem by providing a second enhancement layer provided by subtractor 510 and enhancement encoder 511, which second enhancement layer represents the details lost in the mulitplier 216. In fact, the second enhancement encoder 511 encodes the difference between the input and the output of multiplier 216. The respective encoders 218 and 511 can be optimized for their respective inputs. For example, if present, a variable length encoding can be optimized for the statistics of the respective signals.

The signal produced by the encoder 201+503 can be decoded by the decoder 205 as described hereinbefore. In that case only the base layer and the first enhancement layer are decoded.

To decode the second enhancement layer, decoder 505 is provided which includes a decoder 512 for the second enhancement layer and an adder 513 in addition to the decoder 205. The enhancement layer decoded in decoder 512 is in this embodiment simply added to the output stream of the decoder 205 in order to provide a transparent video resolution in the sense that the resolution of the decoded stream is now similar to the resolution of the input 202.

The above-described embodiments of the invention enhance the efficiency of known spatial scalable compression schemes by lowering the bitrate of the enhancement layer by using adaptive content filtering to remove unnecessary bits from the residual stream prior to encoding. It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor other unit may fulfill the functions of several of the units or circuits recited in the claims.

1. An apparatus for efficiently performing spatial scalable compression of video information captured in a plurality of frames including an encoder for encoding and outputting the captured video frames into a compressed data stream, comprising:
a base layer comprising an encoded bitstream having a relatively low resolution;
a high resolution enhancement layer comprising a residual signal having a relatively high resolution; and
wherein a multiplier unit attenuates the residual signal, the residual signal being the difference between original frames and upscaled frames from the base layer, so as to reduce the number of bits needed.

2. The apparatus for efficiently performing spatial scalable compression of video information according to claim 1, wherein the multiplier attenuates the residual signal by a predetermined amount.

3. The apparatus for efficiently performing spatial scalable compression of video information according to claim 1, wherein the amount of attenuation can be manually changed by a control knob.

4. The apparatus for efficiently performing spatial scalable compression of video information according to claim 1, further comprising: a picture analyzer which receives upscale and/or original frames and calculates a gain value of the content of each pixel in each received frame, wherein the multiplier uses the gain value to attenuate the residual signal.

5. The apparatus for efficiently performing spatial scalable compression of video information according to claim 4, wherein the gain value goes toward zero for areas of little detail.

6. The apparatus for efficiently performing spatial scalable compression of video information according to claim 4, wherein the gain value goes toward one for edges and text areas.

7. The apparatus for efficiently performing spatial scalable compression of video information according to claim 4, wherein the gain value is calculated for a group of pixels.

8. A layered encoder for encoding and decoding a video stream, comprising:
a downsampling unit for reducing the resolution of the video stream;
a base encoder for encoding a lower resolution base stream;
an upconverting unit for decoding and increasing the resolution of the base stream to produce a reconstructed video stream;
a subtractor unit for subtracting the reconstructed video stream from the original video stream to produce a residual signal;
a first multiplier unit which multiplies the residual signal by gain values so as to remove bits from the residual signal for areas which have little detail;
an enhancement encoder for encoding the resulting residual signal from the multiplier and outputting an enhancement stream.

9. The layered encoder according to claim 8, wherein the multiplier attenuates the residual signal by a predetermined amount.

10. The layered encoder according to claim 8, wherein the amount of attenuation can be manually changed by a control knob.

11. The layered encoder according to claim 8, further comprising: a picture analyzer which receives the video stream and the reconstructed video stream and calculates the gain values of the content of each pixel in each frame of the received streams.

12. The layered encoder according to claim 11, wherein the gain value goes toward zero for areas of little detail.

13. The layered encoder according to claim 11, wherein the gain value goes toward one for edges and text areas.

14. The layered encoder according to claim 11, further comprising:
a traditional bitrate control combined with bitrate control via the first multiplier unit; and
a combiner located between the picture analyzer and the first multiplier unit for combining the gain value with encoder statistic parameters from the enhancement encoder and outputting the combined gain value to the first multiplier unit.

15. The layered encoder according to claim 14, wherein the encoder statistics parameters indicate when the available bitrate budget is no longer sufficient for encoding at full resolution of sufficient quality, so that the gain of the first multiplier unit is set to a reduced resolution value in order to meet the available bitrate budget.

16. The layered encoder according to claim 11, wherein the gain value is calculated for a group of pixels.

17. A decoder for decoding compressed video information, comprising: a base stream decoder for decoding a received base stream;
an upconverting unit for increasing the resolution of the of the decoded base stream;
an enhancement stream decoder for decoding a received enhancement stream;
a sharpness control means for outputting a sharpness control value;
a second muliplier unit for multiplying the decoded enhancement stream by the sharpness control value so as to allow a user to control the trade-off between sharpness and the visibility of artifacts in the decoded enhancement stream; and
an addition unit for combining the upconverted decoded base stream and the sharpness controlled enhancement stream to produce a video output.

18. A method for providing spatial scalable compression using adaptive content filtering of a video stream, comprising the steps of:
downsampling the video stream to reduce the resolution of the video stream;
encoding the downsampled video stream to produce a base stream;
decoding and upconverting the base stream to produce a reconstructed video stream;
subtracting the reconstructed video stream from the video stream to produce a residual stream;
multiplying the residual stream by gain values so as to remove bits from the residual stream which represent areas of each frame which have little detail; and
encoding the resulting residual stream and outputting an enhancement stream.

19. The method for providing spatial scalable compression using adaptive content filtering of a video stream according to claim 18, further comprising the step of:
analyzing the video stream and the reconstructed video stream to produce the gain values of the content of each pixel in the frames of the received video streams.

20. The method for providing spatial scalable compression using adaptive content filtering of a video stream according to claim 18, wherein the gain value goes toward zero for areas of little detail.

21. The method for providing spatial scalable compression using adaptive content filtering of a video stream according to claim 18, wherein the gain value goes toward one for edges and text areas.

22. The method for providing spatial scalable compression using adaptive content filtering of a video stream according to claim 18, wherein the gain value is calculated for a group of pixels.

23. The method for providing spatial scalable compression using adaptive content filtering of a video stream according to claim 18, further comprising the step of:
combining the gain value with encoder statistics parameters from the enhancement encoder prior to the multiplying step.

24. The method for providing spatial scalable compression using adaptive content filtering of a video stream according to claim 23, wherein the encoder statistics parameters indicate when the available bitrate budget is no longer sufficient for encoding at full resolution of sufficient quality, so that the gain of a first multiplier unit is set to a reduced resolution value in order to meet the available bitrate budget.

25. A method for decoding compressed video information received in a base stream and an enhancement stream, comprising the steps of: decoding the base stream;
upconverting the decoded base stream to increase the resolution of the decoded base stream;
decoding the enhancement stream;
multiplying the decoded enhancement stream by a sharpness control value, wherein the sharpness control value controls the trade-off between sharpness and the visibility of artifacts in the decoded enhancement stream; and
combining the upconverted decoded base stream with the sharpness controlled enhancement stream to produce a video output.

26. A compressed data stream representing video information comprising:
a base layer comprising an encoded bitstream having a relatively low resolution;
a high resolution enhancement layer comprising a residual signal having a relatively high resolution, the residual signal being a difference between original frames and upscaled frames from the base layer, and wherein the residual signal has been attenuated.

27. A storage medium on which a compressed data stream as claimed in claim 26 has been stored.
